(19) United States
(12) Patent Application Publication
(10) Pub. No.: US 2014/0026477 A1
(43) Pub. Date: Jan. 30, 2014

(54) TREE SUPPORT DEVICE

(71) Applicant: Scott N. Ferguson, Sandy Hook, CT (US)

(72) Inventor: Scott N. Ferguson, Sandy Hook, CT (US)

(21) Appl. No.: 13/557,539

(22) Filed: Jul. 25, 2012

(51) Int. Cl. A47G 33/12; A01G 1/00; A01G 17/14

(52) U.S. Cl. 47/40.5; 47/42; 47/58.1 R

(57) ABSTRACT

Exemplary embodiments of the present invention are directed to a support device for a decorative tree, for example a natural Christmas tree. The support device includes an arcuate member and a cylindrical portion extending substantially perpendicular to the arcuate member. The arcuate member includes at least one elongated gripping tooth positioned on a concave surface of the arcuate member opposite the surface of the arcuate member from which the cylindrical portion extends from. The support device is configured and dimensioned for use with conventional tree stands in order to produce a substantial clamping action around the trunk of the decorative tree in order to hold the decorative tree in a substantially upright position.

### BACKGROUND OF THE INVENTION

1. Technical Field

The present invention relates generally to providing support for cut decorative trees and the like. More particularly, it relates to a tree support device that can be used with conventional tree holders to secure decorative trees in an upright position.

2. Description of the Background Art

A variety of different devices and systems have been employed for supporting decorative trees, such as Christmas trees, once the trees have been removed from their root support system and during the display and/or presentation of the trees.

For example, U.S. Pat. No. 4,825,586 is directed to a Christmas tree stand that includes a bowl, a support collar mounted over the bowl that bears a set of angularly spaced threaded nuts, and a set of turn screws threaded through the support collar nuts. A set of arcuate clamping plates is positioned in a cylindrical formation within the support collar. Each plate has a channel in which an end of one of the turn screws is rotatably captured. With this construction, threaded advancement of the turn screws may cause the arcuate clamping plates to tighten convergently upon a tree trunk positioned within the support collar without the arcuate plates rotating substantially out of their cylindrical formation.

U.S. Pat. No. 4,967,508 is directed to a tree stand that supports either a real, live tree or an artificial tree such as a Christmas tree or other decorative tree. The tree stand includes a container for holding a quantity of liquid nutrient for the tree, the container having a horizontal platform fixed therein to receive the lower end of the tree. A screw threadedly engages the bottom of the container; and, the screw is reversible to present either end upwardly for engaging the tree. One end of the screw is a wood screw for use with a real tree, and the other end is a frustoconical member for engaging the tubular post of an artificial tree. The screw includes a gasket for sealing the container when used for a live tree.

U.S. Pat. No. 5,725,193 is directed to a compact tree stand that has a generally cylindrical container having an open top, closed bottom and a wall extending there between which together define a central cavity. A plurality of legs are releasably attached to the exterior of the container and may be interconnected by braces. The cavity and the legs are sized so that the diameter of the cavity is greater than the height of the legs half the length of each leg is less than the depth of the cavity. This enables the legs to be nested within the cavity so that the tree stand can be placed in a relatively small box for shipment and sale. An inner cup can be placed within the cavity and may rotate relative to the container. Stepped ribs or an insert having a conical cavity may be placed within the inner cup or the container to enable the tree stand to hold artificial trees having different trunk diameters.

U.S. Pat. No. 7,044,427 is directed to a Christmas tree stand of the kind having a container to receive water and a tree trunk and a plurality of stabilizing legs radiating outwardly from the side walls of the container includes a novel clamping mechanism including a plurality of gripping means, each made up of a plunger having a concave tree clamping portion, a pair of parallel arms extending there from with free distal ends and resiliently joined at the front of the tree clamping portion. The arms of the plunger extend through a guide member and resiliently releasable locking means are provided, whereby the plunger can be readily pushed forward to press against the tree trunk but is locked against outward movement unless and until the arms of the plunger are squeezed together to release the locking means. U.S. Application Publication No. 2005/0051695 is directed to a plurality of tree grips each having a longitudinal axis and a transverse axis in combination with a tree stand for use in securing a tree in the stand. Each of the tree grips includes a first surface and a second surface oriented and facing oppositely to the first surface. The first surface includes a plurality of protrusions and the second surface includes a vertically offset bore. The tree stand includes a circumferentially oriented support and a plurality of threaded members oriented radially inwardly with respect to the circumferentially oriented support. The circumferentially oriented support includes respective female threads for interengaging the plurality of threaded members preventing movement of the threaded members relative to the circumferentially oriented support. Each of the threaded members engage a respective bore in each of the respective tree grips thus restraining outward radial movement of the tree grips. The plurality of protrusions substantially engage the tree to secure it within the stand in a vertical position.

### SUMMARY OF THE INVENTION

The present invention is designed to overcome the limitations that are attendant upon the use of conventional tree stands and, toward this end, it contemplates the provision of a novel tree support device that adapts to any existing tree stand thumb screws to support a tree, such as an ornamental tree and more particularly a Christmas tree.

It is an object of the present invention to provide a novel clamping apparatus to support ornamental trees of any size and/or shape that may be quickly adjusted to support the tree in an upright position.

Another object of the present invention is to product such a holder or clamping apparatus which may be formed of relatively light stock and at the same time is strong and capable enough to support trees, such as ornamental trees, of substantial size and weight.

It is yet another object of the present invention that the holder or clamping apparatus inserts over existing thumb screws or other fasteners used on conventional tree stands to support the tree by covering more surface area of the trunk of the tree itself, and thereby holding the tree in a more secure manner.

It has now been found that the foregoing and related objects can be readily attained in a support device in accordance with an exemplary embodiment of the present invention, that includes an arcuate member having a concave surface, and a convex surface positioned on the arcuate member substantially parallel to the concave surface, a cylindrical portion extending from the convex surface of the arcuate member and having a cavity defined therein, and at least one elongated gripping tooth positioned along a longitudinal direction of the concave surface of the arcuate member.

In accordance with this exemplary embodiment of the present invention, the cylindrical portion may be positioned substantially perpendicular to the arcuate member.

In accordance with this exemplary embodiment of the present invention, the arcuate member has a length extending along a first direction, and a height extending along a second direction substantially perpendicular to the length.

In accordance with this exemplary embodiment of the present invention, the length of the arcuate member is greater than the height of the arcuate member.

In accordance with this exemplary embodiment of the present invention, the at least one elongated gripping tooth extends in the first direction at least partially along the length of the arcuate member on the concave surface.

In accordance with this exemplary embodiment of the present invention, the support device may also include a plurality of elongated gripping teeth, and each elongated gripping tooth of the plurality of elongated gripping teeth is positioned substantially parallel to at least one other elongated gripping tooth.

In accordance with this exemplary embodiment of the present invention, the at least one elongated gripping tooth may include a first side and a second side extending from the concave surface of the arcuate member, and intersecting to form a peak of the elongated gripping tooth.

In accordance with this exemplary embodiment of the present invention, the convex surface comprises a principle axis, and the cylindrical portion is positioned substantially concentric with the principle axis of the convex surface.

In accordance with this exemplary embodiment of the present invention, the cylindrical portion is operatively connected to the convex surface so as to permit rotational movement of the cylindrical portion about the principle axis of the convex surface.

In accordance with this exemplary embodiment of the present invention, the cylindrical portion may include an end and an opening defined at the end, and the cavity of the cylindrical portion extends from the arcuate member to the opening defined at the end of the cylindrical portion.

In accordance with this exemplary embodiment of the present invention, the support device may also include a plurality of elongated gripping teeth, and each of the plurality of elongated gripping teeth are positioned substantially parallel with the first direction.

In accordance with this exemplary embodiment of the present invention, each of the plurality of elongated gripping teeth are positioned substantially adjacent to each other in the second direction.

In accordance with this exemplary embodiment of the present invention, the cavity of the cylindrical portion is configured for operative engagement with a thumb screw of a stand configured to support a decorative tree.

Another alternative embodiment of the present invention is directed to a tree holder that may include a bucket dimensioned to receive a trunk of a decorative tree, at least one support leg extending from the bucket, and configured to hold the bucket in a substantially upright position, at least one thumb screw operatively connected to the at least one support leg, and at least one support device operatively connected to the at least one thumb screw, and configured for supporting engagement with at least a portion of the trunk of the decorative tree.

In accordance with this other exemplary embodiment of the present invention, the at least one support device may include an arcuate member having a concave surface, and a convex surface positioned on the arcuate member substantially parallel to the concave surface, a cylindrical portion extending from the convex surface of the arcuate member and having a cavity defined therein, and at least one elongated gripping tooth positioned along a longitudinal direction of the concave surface of the arcuate member.

In accordance with this exemplary embodiment of the present invention, the arcuate member of the at least one support device has a length extending along a first direction, and a height extending along a second direction substantially perpendicular to the length.

In accordance with this exemplary embodiment of the present invention, the length of the arcuate member is greater than the height of the arcuate member.

In accordance with this exemplary embodiment of the present invention, the at least one elongated gripping tooth extends in the first direction at least partially along the length of the arcuate member on the concave surface.

In accordance with this exemplary embodiment of the present invention, the at least one support device may also include a plurality of elongated gripping teeth, and each elongated gripping tooth of the plurality of elongated gripping teeth is positioned substantially parallel to at least one other elongated gripping tooth.

In accordance with this exemplary embodiment of the present invention, the at least one support device may also include a plurality of elongated gripping teeth, and each of the plurality of elongated gripping teeth are positioned substantially parallel with the first direction.

Another alternative embodiment of the present invention is directed to a method of supporting a decorative tree, where the method may include providing a tree holder that may include a bucket dimensioned to receive a trunk of the decorative tree, at least one support leg extending from the bucket, and configured to hold the bucket in a substantially upright position, at least one thumb screw operatively connected to the at least one support leg, and at least one support device operatively connected to the at least one thumb screw, and configured for supporting engagement with at least a portion of the trunk of the decorative tree.

In accordance with this exemplary embodiment of the present invention, the at least one support device may include an arcuate member having a concave surface, and a convex surface positioned on the arcuate member substantially parallel to the concave surface, a cylindrical portion extending from the convex surface of the arcuate member and having a cavity defined therein, and at least one elongated gripping tooth positioned along a longitudinal direction of the concave surface of the arcuate member.

In accordance with this exemplary embodiment of the present invention, the method may also include inserting the trunk of the decorative tree into the bucket so that the bucket substantially surrounds a base of the trunk of the decorative tree, adjusting the at least one thumb screw in order to advance the at least one support device towards the trunk of the decorative tree, and securing the support device to the trunk of the decorative tree so that the at least one elongated gripping tooth engages with the trunk of the decorative tree.

In accordance with this exemplary embodiment of the present invention, the arcuate member of the at least one support device has a length extending along a first direction, and a height extending along a second direction substantially perpendicular to the length.

In accordance with this exemplary embodiment of the present invention, the length of the arcuate member is greater than the height of the arcuate member.

In accordance with this exemplary embodiment of the present invention, the at least one elongated gripping tooth extends in the first direction at least partially along the length of the arcuate member on the concave surface.

In accordance with this exemplary embodiment of the present invention, the at least one support device may also include a plurality of elongated gripping teeth, and each elongated gripping tooth of the plurality of elongated gripping teeth is positioned substantially parallel to at least one other elongated gripping tooth.

In accordance with this exemplary embodiment of the present invention, the at least one support device may also include a plurality of elongated gripping teeth, and each of the plurality of elongated gripping teeth are positioned substantially parallel with the first direction.

### BRIEF DESCRIPTION OF THE DRAWINGS

Having thus described the invention in general terms, reference will now be made to the accompanying drawings, which are not necessarily drawn to scale, where:

FIG. 1 is an isometric view of an exemplary tree support device in accordance with the present invention;

FIG. 2 is a front view of the exemplary tree support device in accordance with the present invention;

FIG. 3 is a top plan view of the exemplary tree support device in accordance with the present invention;

FIG. 4 is a rear view of the exemplary tree support device in accordance with the present invention;

FIG. 4A is a cross-sectional view of the exemplary tree support device taken along line 4A-4A in FIG. 4;

FIG. 5 is a left-side view of the exemplary tree support device in accordance with the present invention;

FIG. 6 is a top plan view of exemplary tree support devices in use on a tree holder to support a decorative tree;

FIG. 7 is an isometric view of exemplary tree support devices in use on the tree holder to support the decorative tree;

FIG. 8 a top plan view of the exemplary tree support device installed on a thumb screw with a portion of the tree support device cutaway in order to show the interaction of the thumb screw with the tree support device;

FIG. 9 is a front view of another exemplary embodiment of a tree support device in accordance with the present invention;

FIG. 10 is an isometric view of the other exemplary embodiment of the tree support device in accordance with the present invention;

FIG. 11 is a rear view of the other exemplary embodiment of the tree support device in accordance with the present invention;

FIG. 12 is a cross-sectional view of the other exemplary embodiment of the tree support device taken along line 12-12 in FIG. 11;

FIG. 13 is a top plan view of the other exemplary embodiment of the tree support device in accordance with the present invention;

FIG. 14 is an exploded isometric view of another exemplary embodiment of the tree support device in accordance with the present invention;

FIG. 15 is a top plan view of the other exemplary embodiment of the tree support device in accordance with the present invention; and

FIG. 16 a top plan view of the other exemplary tree support device installed on a thumb screw with a portion of the tree support device cutaway in order to show the interaction of the thumb screw with the tree support device.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

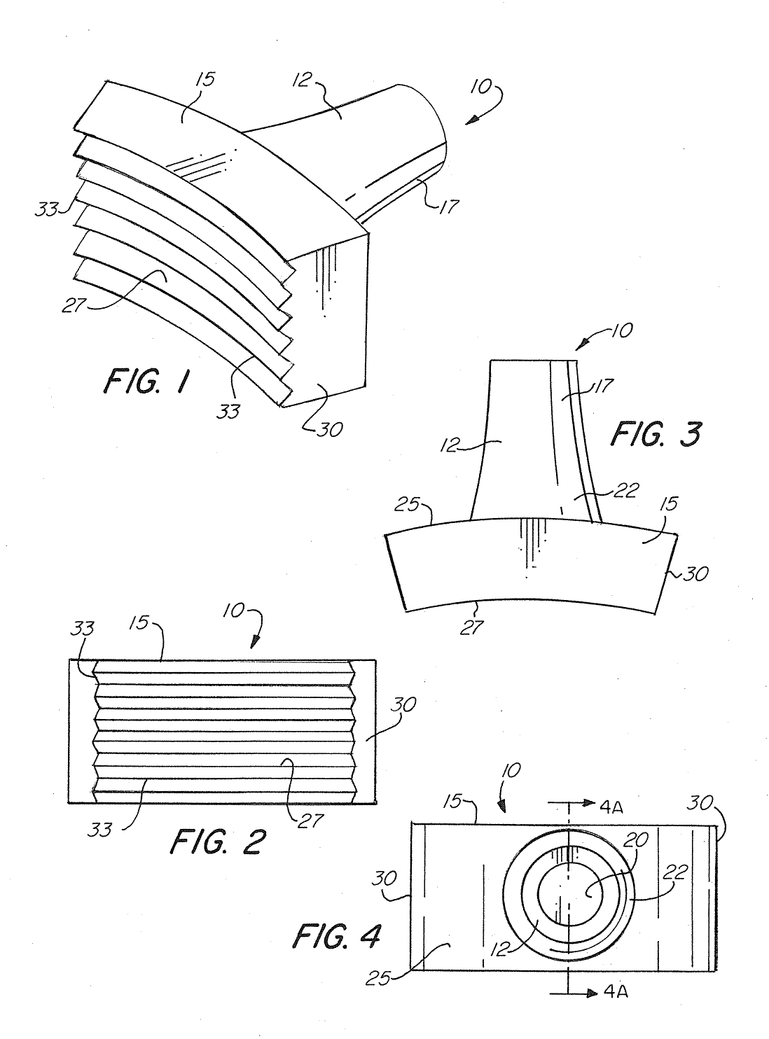

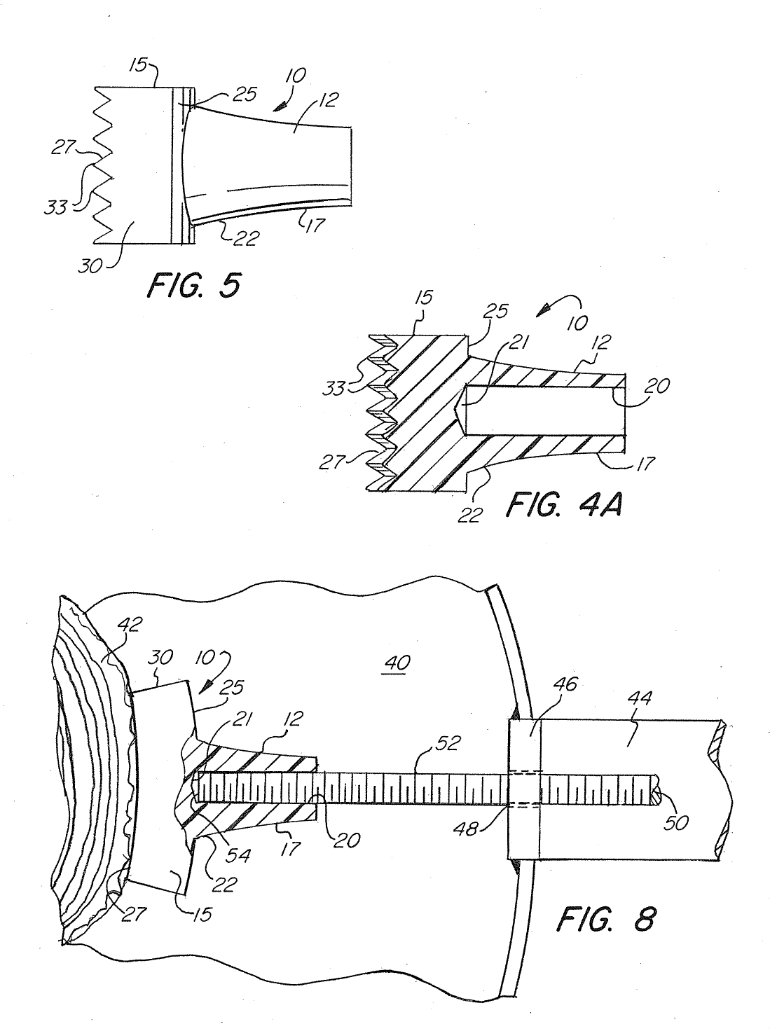

FIGS. 1-4, 4A and 5 show an exemplary embodiment of a support device, generally indicated by reference numeral 10, according to the present invention. The support device 10 may be used to hold and support a tree, for example a natural Christmas tree. The support device 10 includes a hollow stem 12 and an arcuate member 15 connected to and extending from the hollow stem 12. The arcuate member 15 and hollow stem 12 may be integrally formed with each other, or the arcuate member 15 and hollow stem 12 may be formed as separate components and joined together by a suitable adhesive, such as glue and/or an epoxy, or welded together with suitable techniques. The hollow stem 12 includes a substantially cylindrical portion 17 surrounding a cavity 20 formed within the hollow stem 12. The cavity 20 includes a base 21 at the end of the cavity 20 positioned on, in or near the arcuate member 15. The hollow stem 12 may also include a conical tapered portion 22 at the section of the hollow stem 12 that connects to the arcuate member 15.

Still referring to FIGS. 1-4, 4A and 5, the arcuate member 15 of the support device 10 may include a convex surface 25 connected to the hollow stem 12, and a concave surface 27 that may be positioned on a side of the arcuate member 15 opposite the convex surface 25 and the hollow stem 12. The arcuate member 15 may also include a side 30 positioned at each end of the convex surface 25 and the concave surface 27. The arcuate member 15 also includes at least one elongated gripping tooth 33 formed on and/or extending from the concave surface 27. The at least one elongated gripping tooth 33 may be positioned substantially perpendicular to the sides 30 of the arcuate member 15, and may be positioned lengthwise on and/or extending from the concave surface 27.

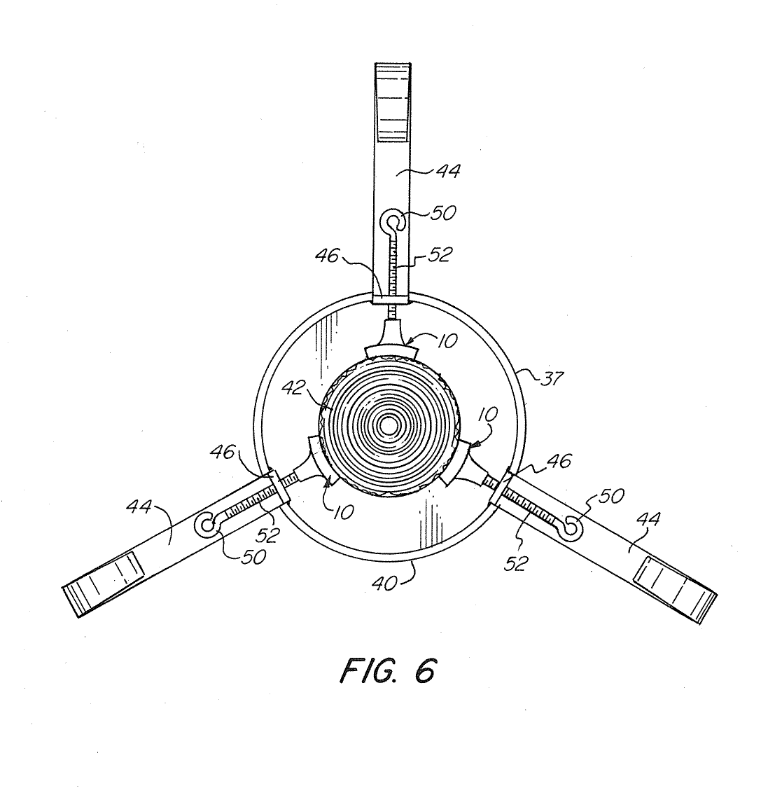

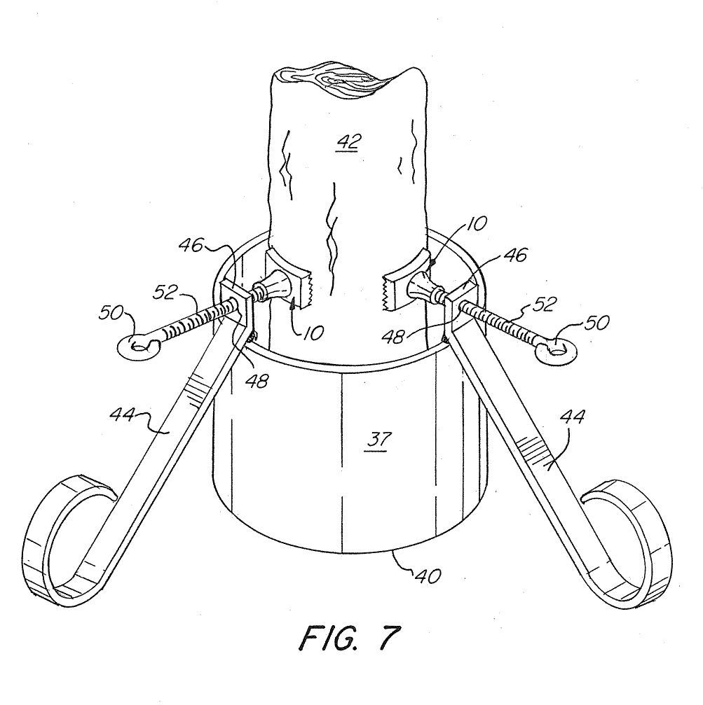

An exemplary use of the support device 10 is shown in FIGS. 6-8. The support device 10 may be used with any standard tree holder 37. For example, the tree holder 37 may include a substantially circular bucket 40 that is configured and dimensioned to hold a tree trunk 42, for example a Christmas tree trunk, and water (not shown) for the tree trunk 42. The tree holder 37 may also include one or more support legs 44 positioned around the substantially circular bucket 40 so as to be able to support the substantially circular bucket 40 in an upright position. Each of the one or more support legs 44 may include an upwardly extending tab 46 that includes a threaded hole 48 in it. The threaded hole 48 is dimensioned to receive a thumb screw 50, which may be adjusted in a direction towards the interior of the substantially circular bucket 40 or away from the substantially circular bucket 40 by rotating the thumb screw 50 about its longitudinal axis in the appropriate direction. The cavity 20 of the hollow stem 12 of the support device 10 is dimensioned so that the thumb screw 50 can be inserted into the hollow stem 12. The cavity 20 may be threaded so that the threads 52 of the thumb screw 50 operatively engage with the threads (not shown) within the cavity 20. However, the cavity 20 of the hollow stem 12 may also be unthreaded. Whether the cavity 20 is threaded or unthreaded, in operation, the thumb screw 50 is inserted into the cavity 20 until the end 54 of the thumb screw 50 engages with the base 21 of the cavity 20. As a result, as the thumb screw 50 is rotated about its longitudinal axis so that the thumb screw 50 moves in a direction towards the interior of the substantially circular bucket 40 the support device 10 is also moved in a direction towards the interior of the substantially circular bucket 40. When the tree trunk 42 is placed within the substantially circular bucket 40 the support device 10 is urged towards the tree trunk 42 by the rotation of the thumb screw 50 until the at least one elongated gripping tooth 33 positioned on and/or extending from the concave surface 27 engage with the tree trunk 42. More than one, for example three, support devices 10 can be used to support and hold the tree trunk 42 in an upright position. However, it is understood that any suitable number of support devices 10 in combination with appropriate thumb screws 50 can be used to support and hold the tree trunk 42 in an upright position, and the present invention is not limited to the use of three support devices 10.

When removal of the tree trunk 42 is desired, the thumb screw 50 can be rotated so that the thumb screw 50 moves in a direction away from the tree trunk 42 so that the support device 10 positioned on the end 54 of the thumb screw 50 disengages from the tree trunk 42, thereby permitting removal of the tree trunk 42 from the substantially circular bucket 40 of the tree holder 37. The support device 10 may be disengaged from the tree trunk 42 as a result of either the support device 10 moving away from the tree trunk 42 in response to the movement of the thumb screw 50, or as a result of the end 54 of the thumb screw 50 disengaging from the base 21 of the cavity 20 of the support device 10 in order to permit the support device 10 to be moved away from the tree trunk 42. The support device 10 may be made from any suitable material, for example plastics such as polyvinyl chloride (PVC), hard rubbers, urethanes and/or metals. Different components of the support device 10 may be made from separate materials, for example the hollow stem 12 may be made from a metal, while the arcuate member 15 may be made from a plastic.

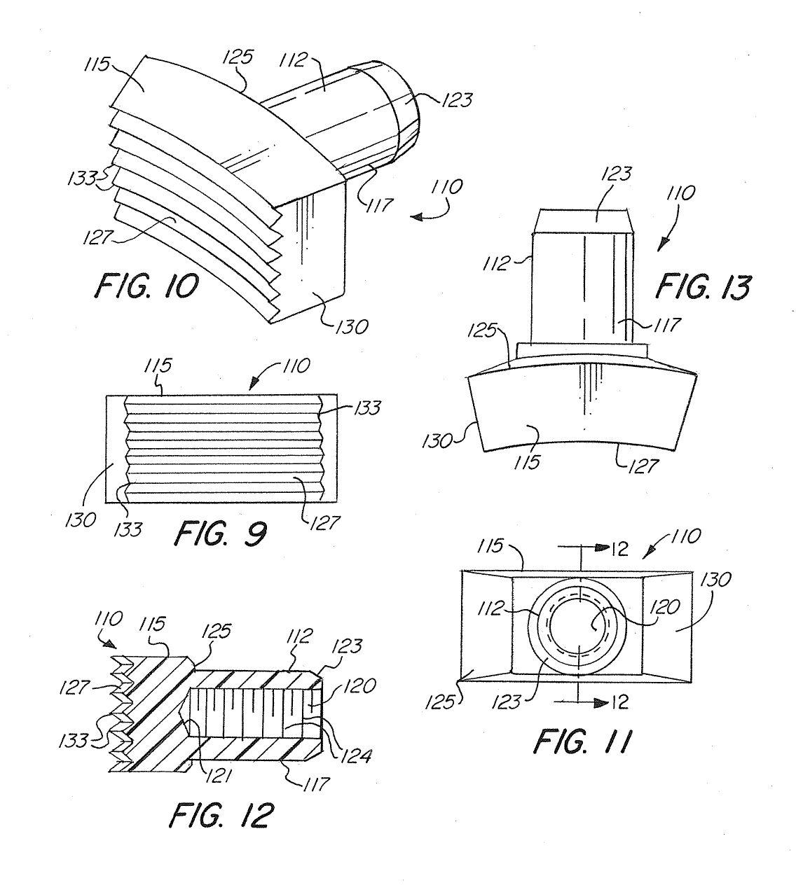

FIGS. 9-13 show another exemplary embodiment of a support device, generally indicated by reference numeral 110, according to the present invention. Features of this exemplary embodiment of the invention that correspond to similar features of the first exemplary embodiment of the invention are identified by a reference numeral increased by 100 from the reference numeral used to identify the similar feature of the first exemplary embodiment. The support device 110 may be used to hold and support a tree, for example a natural Christmas tree. The support device 110 includes a hollow stem 112 and an arcuate member 115 connected to and extending from the hollow stem 112. The arcuate member 115 and hollow stem 112 may be integrally formed with each other, or the arcuate member 115 and hollow stem 112 may be formed as separate components and joined together by a suitable adhesive, such as glue and/or an epoxy, or welded together with suitable techniques. The hollow stem 112 includes a substantially cylindrical portion 117 surrounding a cavity 120 formed within the hollow stem 112. The cavity 120 includes a base 121 at the end of the cavity 120 positioned on, in or near the arcuate member 115. The hollow stem 112 may also include a conical end portion 123 at the end of the hollow stem 112. The cavity 120 may include threads 124 formed in the interior surface of the cavity 120, but it is understood that the interior surface of the cavity may also be unthreaded.

Still referring to FIGS. 9-13, the arcuate member 115 of the support device 110 may include a convex surface 125 connected to the hollow stem 112, and a concave surface 127 that may be positioned on a side of the arcuate member 115 opposite the convex surface 125 and the hollow stem 112. The arcuate member 115 may also include a side 130 positioned at each end of the convex surface 125 and the concave surface 127. The arcuate member 115 also includes at least one elongated gripping tooth 133 formed on and/or extending from the concave surface 127. The at least one elongated gripping tooth 133 may be positioned substantially perpendicular to the sides 130 of the arcuate member 115, and may be positioned lengthwise on and/or extending from the concave surface 127.

It is understood that the support device 110 according to this exemplary embodiment of the present invention can be used in the same manner and for the same and/or similar purposes as the exemplary support device 10 that were discussed above with respect to the first exemplary embodiment of the present invention. Furthermore, the support device 110 may be made from any suitable material, for example plastics such as polyvinyl chloride (PVC), hard rubbers, urethanes and/or metals. Different components of the support device 110 may be made from separate materials, for example the hollow stem 112 may be made from a metal, while the arcuate member 115 may be made from a plastic.

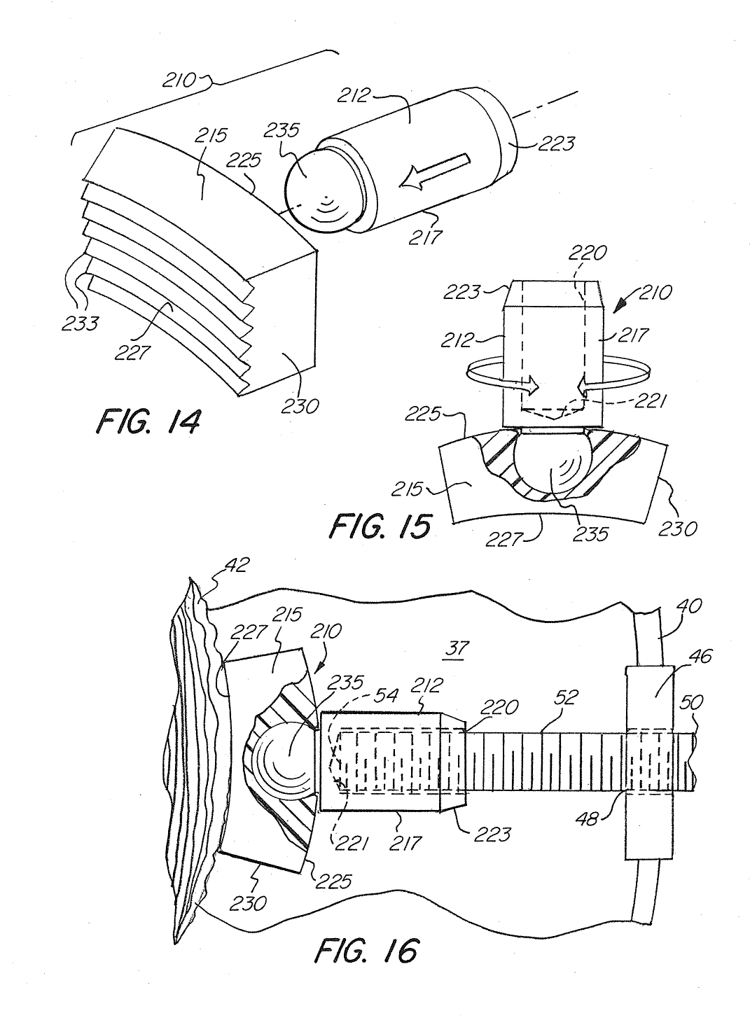

FIGS. 14-16 show another exemplary embodiment of a support device, generally indicated by reference numeral 210, according to the present invention. Features of this exemplary embodiment of the invention that correspond to similar features of the first exemplary and/or second embodiments of the invention are identified by a reference numeral increased by 200 from the reference numeral used to identify the similar feature of the first exemplary embodiment or 100 from the reference numeral used to identify the similar feature of the second exemplary embodiment. The support device 210 may be used to hold and support a tree, for example a natural Christmas tree. The support device 210 includes a hollow stem 212 and an arcuate member 215 connected to and extending from the hollow stem 212. The hollow stem 212 includes a substantially cylindrical portion 217 surrounding a cavity 220 formed within the hollow stem 212. The cavity 220 includes a base 221 at the end of the cavity 220 that may be positioned on, in or near the arcuate member 215. The hollow stem 212 may also include a conical end portion 223 at the end of the hollow stem 212. The arcuate member 215 of the support device 210 may include a convex surface 225 connected to the hollow stem 212, and a concave surface 227 that may be positioned on a side of the arcuate member 215 opposite the convex surface 225 and the hollow stem 212. The arcuate member 215 may also include a side 230 positioned at each end of the convex surface 225 and the concave surface 227. The arcuate member 215 also includes at least one elongated gripping tooth 233 formed on and/or extending from the concave surface 227. The at least one elongated gripping tooth 233 may be positioned substantially perpendicular to the sides 230 of the arcuate member 215, and may be positioned lengthwise on and/or extending from the concave surface 227.

Still referring to FIGS. 14-16, the support device 210 may also include a ball bearing 235 positioned between the hollow stem 212 and the arcuate member 215. The ball bearing 235 permits the hollow stem 212 to rotate freely about its longitudinal axis without imparting substantial rotation to the arcuate member 215. In this manner, as shown in FIG. 16, when the thumb screw 50 is rotated so as to cause the support device 210 to move in a direction towards the tree trunk 42, the arcuate member 210 maintains its desired orientation relative to the tree trunk 42 due to the free rotation of the hollow stem 212 as a result of the ball bearing 235 positioned between the hollow stem 212 and the arcuate member 215.

It is understood that the support device 210 according to this exemplary embodiment of the present invention can be used in the same manner and for the same and/or similar purposes as the exemplary support device 10 that were discussed above with respect to the first exemplary embodiment of the present invention. For example, the engagement of a thumb screw 50 of an exemplary tree holder 37 with the support device 210 according to this exemplary embodiment of the present invention is shown in FIG. 16. Furthermore, the support device 210 may be made from any suitable material, for example plastics such as polyvinyl chloride (PVC), hard rubbers, urethanes and/or metals. Different components of the support device 210 may be made from separate materials, for example the hollow stem 212 may be made from a metal, while the arcuate member 215 may be made from a plastic.

It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

1. A support device, comprising:
an arcuate member having a concave surface, and a convex surface positioned on the arcuate member substantially parallel to the concave surface;
a cylindrical portion having a cavity defined therein, wherein the cylindrical portion extends from the convex surface of the arcuate member; and
at least one elongated gripping tooth positioned along a longitudinal direction of the concave surface of the arcuate member.

2. The support device according to claim 1, wherein the cylindrical portion is positioned substantially perpendicular to the arcuate member.

3. The support device according to claim 1, wherein the arcuate member has a length extending along a first direction, and a height extending along a second direction substantially perpendicular to the length;
wherein the length of the arcuate member is greater than the height of the arcuate member; and
wherein the at least one elongated gripping tooth extends in the first direction at least partially along the length of the arcuate member on the concave surface.

4. The support device according to claim 3, wherein the support device further comprises a plurality of elongated gripping teeth, and each elongated gripping tooth of the plurality of elongated gripping teeth is positioned substantially parallel to at least one other elongated gripping tooth.

5. The support device according to claim 1, wherein the at least one elongated gripping tooth comprises a first side and a second side extending from the concave surface of the arcuate member, and intersecting to form a peak of the elongated gripping tooth.

6. The support device according to claim 1, wherein the convex surface comprises a principle axis, and wherein the cylindrical portion is positioned substantially concentric with the principle axis of the convex surface.

7. The support device according to claim 1, wherein the cylindrical portion comprises an end and an opening defined at the end, and wherein the cavity of the cylindrical portion extends from the arcuate member to the opening defined at the end of the cylindrical portion.

8. The support device according to claim 3, wherein the support device further comprises a plurality of elongated gripping teeth, and wherein each of the plurality of elongated gripping teeth are positioned substantially parallel with the first direction.

9. The support device according to claim 8, wherein each of the plurality of elongated gripping teeth are positioned substantially adjacent to each other in the second direction.

10. The support device according to claim 1, wherein the cavity of the cylindrical portion is configured for operative engagement with a thumb screw of a stand configured to support a decorative tree.

11. The support device according to claim 6, wherein the cylindrical portion is operatively connected to the convex surface so as to permit rotational movement of the cylindrical portion about the principle axis of the convex surface.

12. A tree holder, comprising:
a bucket dimensioned to receive a trunk of a decorative tree;
at least one support leg extending from the bucket, and configured to hold the bucket in a substantially upright position;
at least one thumb screw operatively connected to the at least one support leg; and
at least one support device operatively connected to the at least one thumb screw, and configured for supporting engagement with at least a portion of the trunk of the decorative tree;
wherein the at least one support device comprises an arcuate member having a concave surface, and a convex surface positioned on the arcuate member substantially parallel to the concave surface, a cylindrical portion having a cavity defined therein, wherein the cylindrical portion extends from the convex surface of the arcuate member, and at least one elongated gripping tooth positioned along a longitudinal direction of the concave surface of the arcuate member.

13. The tree holder according to claim 12, wherein the arcuate member of the at least one support device has a length extending along a first direction, and a height extending along a second direction substantially perpendicular to the length;
wherein the length of the arcuate member is greater than the height of the arcuate member; and
wherein the at least one elongated gripping tooth extends in the first direction at least partially along the length of the arcuate member on the concave surface.

14. The tree holder according to claim 13, wherein the at least one support device further comprises a plurality of elongated gripping teeth, and each elongated gripping tooth of the plurality of elongated gripping teeth is positioned substantially parallel to at least one other elongated gripping tooth.

15. The tree holder according to claim 13, wherein the at least one support device further comprises a plurality of elongated gripping teeth, and wherein each of the plurality of elongated gripping teeth are positioned substantially parallel with the first direction.

16. A method of supporting a decorative tree, comprising:
providing a tree holder comprising:
a bucket dimensioned to receive a trunk of the decorative tree;
at least one support leg extending from the bucket, and configured to hold the bucket in a substantially upright position;
at least one thumb screw operatively connected to the at least one support leg; and
at least one support device operatively connected to the at least one thumb screw, and configured for supporting engagement with at least a portion of the trunk of the decorative tree;
wherein the at least one support device comprises an arcuate member having a concave surface, and a convex surface positioned on the arcuate member substantially parallel to the concave surface, a cylindrical portion having a cavity defined therein, wherein the cylindrical portion extends from the convex surface of the arcuate member, and at least one elongated gripping tooth positioned along a longitudinal direction of the concave surface of the arcuate member;
inserting the trunk of the decorative tree into the bucket so that the bucket substantially surrounds a base of the trunk of the decorative tree,
adjusting the at least one thumb screw in order to advance the at least one support device towards the trunk of the decorative tree, and
securing the support device to the trunk of the decorative tree so that the at least one elongated gripping tooth engages with the trunk of the decorative tree.

17. The method according to claim 16, wherein the arcuate member of the at least one support device has a length extending along a first direction, and a height extending along a second direction substantially perpendicular to the length;
wherein the length of the arcuate member is greater than the height of the arcuate member; and
wherein the at least one elongated gripping tooth extends in the first direction at least partially along the length of the arcuate member on the concave surface.

18. The method according to claim 17, wherein the at least one support device further comprises a plurality of elongated gripping teeth, and each elongated gripping tooth of the plurality of elongated gripping teeth is positioned substantially parallel to at least one other elongated gripping tooth.

19. The method according to claim 17, wherein the at least one support device further comprises a plurality of elongated gripping teeth, and wherein each of the plurality of elongated gripping teeth are positioned substantially parallel with the first direction.
